(19) United States
(12) Patent Application Publication
(10) Pub. No.: US 2026/0099268 A1
(43) Pub. Date: Apr. 9, 2026

(54) SYSTEMS AND METHODS FOR MOVEABLE MEDIA DRIVES FOR USE IN A MEDIA LIBRARY

(71) Applicant: Quantum Corporation, Centennial, CO (US)

(72) Inventor: Bruno Hald, Parker, CO (US)

(73) Assignee: Quantum Corporation, Centennial, CO (US)

(21) Appl. No.: 18/911,120

(22) Filed: Oct. 9, 2024

(51) Int. Cl. G06F 3/06

(52) U.S. Cl. CPC G06F 3/0655; G06F 3/0613; G06F 3/0682

(57) ABSTRACT

Systems and techniques for providing increased efficiency and throughput in a media library. The media library may include a plurality of media drives arranged in two or more columns in a media drive portion of the media library. The media drives may be moveable media drives configured to move between a plurality of positions in the media drive portion to facilitate access to media drives as needed.

### BACKGROUND

Automated media library systems (or “media libraries”), such as automated tape library systems (or “tape libraries”), are commonly utilized for purposes of writing data to and reading data from media cartridges, such as magnetic tape cartridges configured to retain and/or store magnetic tape that can be used in a magnetic tape drive for purposes of reading and writing data.

### SUMMARY

Some embodiments provide for a media library system. The media library system comprises a frame; a media storage portion supported by the frame, the media storage portion comprising a plurality of storage magazines each having multiple media storage slots configured to hold at least one media cartridge; a media drive portion supported by the frame, the media drive portion comprising a plurality of moveable drives arranged in two or more columns of drives, each particular drive of one or more of the plurality of moveable drives being configured to read data from a media cartridge when the media cartridge is inserted into the particular drive, the plurality of moveable drives comprising: a first set of moveable drives are arranged in a first column; and a second set of moveable drives are arranged in a second column, wherein moveable drives in the plurality of moveable drives are configured to be moved among multiple positions in the media drive portion; and a robotic picker device configured to selectively retrieve a media cartridge from a storage slot in the media storage portion and place the media cartridge into one of the plurality of moveable drives in the first position.

Some embodiments provide for a media library system. The media library system comprises a frame; a media storage portion supported by the frame, the media storage portion comprising a plurality of storage slots configured to hold a respective plurality of media cartridges therein; a media drive portion supported by the frame, the media drive portion comprising a plurality of moveable drives physically arranged in two or more columns of drives, each particular drive of one or more of the plurality of moveable drives being configured to read data from a media cartridge when the media cartridge is inserted into the particular drive, and wherein the moveable drives are configured to be moved between a plurality of positions in the media drive portion; and a robotic picker device configured to selectively retrieve a media cartridge from a storage slot in the media storage portion and place the media cartridge into one of the plurality of moveable drives.

Some embodiments provide for a method performed by a media library system, the media library system comprising a plurality of storage slots configured to receive media cartridges, a plurality of moveable drives arranged in two or more columns including a first column having moveable drives in a first position and a second column having moveable drives in a second position, a robotic picker device, and a controller. The method comprises causing the controller to perform: identifying one or more moveable drives in the first column to be moved; causing movement of the identified one or more moveable drives out of the first column to provide a space in the first column; and causing movement of one or more moveable drives out of the second column and into the space in the first column.

### BRIEF DESCRIPTION OF THE DRAWINGS

Various aspects and embodiments will be described herein with reference to the following figures. It should be appreciated that the figures are not necessarily drawn to scale. Items appearing in multiple figures are indicated by the same or similar reference number in all the figures in which they appear.

FIG. 1 depicts an example media library system, according to some embodiments.

FIG. 2 depicts an exploded perspective view of the example media library system of FIG. 1, according to some embodiments.

FIG. 3 is a block diagram showing a top view of an example media library system, according to some embodiments.

FIG. 4A depicts a perspective view of an example media cartridge storage magazine for use in a media library system, according to some embodiments.

FIG. 4B depicts a cross-sectional view of a portion of an example media cartridge storage magazine, according to some embodiments.

FIG. 5A depicts a top view of an example multi-column media drive system for use in a media library system, according to some embodiments.

FIG. 5B depicts a front view of an example multi-column media drives system for use in a media library system having moveable drives in a first arrangement, according to some embodiments.

FIG. 5C depicts a front view of the example multi-column media drive system of FIG. 5B having moved a moveable drive out of the first column to create a space and moving another drive from the second column into the space created in the first column, according to some embodiments.

FIG. 5D depicts a front view of the example multi-column media drive system of FIG. 5B having moved a subset of moveable drives out of the first column to create a space and moving another subset of drives from the second column into the space created in the first column, according to some embodiments.

FIG. 5E depicts a front view of the example multi-column media drive system of FIG. 5B having moved all drives out of the first column to create a space and moving all drives in the second column into the space created, according to some embodiments.

FIG. 5F depicts a front view of the example multi-column media drive system of FIG. 5B having moved each column of moveable drives with additional media cartridges inserted into the second column, according to some embodiments.

FIG. 5G is a flow chart of an example process for moving one or more moveable drives among multiple positions in a media drive system, according to some embodiments.

FIG. 6 depicts an example dual-slot robotic picker device for use in a media library system, according to some embodiments.

FIG. 7A depicts a perspective view of a media cartridge storage slot and a robotic picker device in a first position, according to some embodiments.

FIG. 7B depicts a perspective view of a media cartridge storage slot and a robotic picker device in a second position, according to some embodiments.

FIG. 7C depicts a perspective view of a media cartridge storage slot and a robotic picker device in a third position, according to some embodiments.

FIG. 8 is a flow chart for an example process of retrieving a media cartridge from a media cartridge storage slot of a media library, according to some embodiments.

FIG. 9 shows a block diagram of an example computing device that may be used to implement embodiments of the technology described herein, according to some embodiments.

### DETAILED DESCRIPTION

Automated media library systems (or “media libraries”), such as automated tape library systems (or “tape libraries”), are commonly utilized for purposes of writing data to and reading data from media cartridges, such as tape cartridges or magnetic tape cartridges. Media cartridges are configured to retain and/or store a storage medium that can be used in a media drive for purposes of writing data to and reading data from the storage medium. In some media libraries, tape cartridges have been used because they provide a convenient way to house and support a length of tape for engagement by a transducer (or tape head, sometimes referred to as a “head”) in the tape drive while protecting the magnetic tape upon removal of the tape cartridge. Moreover, tape cartridges facilitate economic and compact storage of data. During use of the tape drive, a tape head of the tape drive is configured to be in direct contact with the tape from the magnetic tape cartridge so that data can be written to and read from the tape as the tape moves across the tape head, often at high speed. Such tape heads can include dedicated write heads, dedicated read heads, or combination read/write heads.

The media cartridges are received and retained (and stored) within storage slots of the media library when not being used for purposes of writing data to and/or reading data from the media cartridge. In various embodiments, the media library can include a plurality of storage slots that are incorporated within one or more magazines. When it is desired to perform a write operation and/or a read operation on the storage medium within a given media cartridge, such as upon request of a user or host application, a media cartridge retrieval assembly (also referred to herein as a “retrieval assembly”) of the tape library is used to retrieve the media cartridge and move the media cartridge between the storage slot and a media drive of the media library. In many embodiments, the retrieval assembly includes a robotic picker device having a pair of picker fingers that are configured to selectively grasp the media cartridge for purposes of moving the media cartridge between the storage slot and the media drive. Upon completion of the desired write operation and/or read operation, the retrieval assembly and/or the robotic picker device can then return the media cartridge to an appropriate storage slot.

The inventors have recognized that it is desirable to increase the storage capacity and throughput of media libraries in storage facilities, which hold multiple media libraries. Storage facilities typically arrange multiple media libraries in a defined space, with each media library having the same or similar size and configuration. For example, many storage facilities store media libraries having the same width, for example, of approximately 600 millimeters. Limiting the physical footprint of the media libraries stored within a storage facility to a width of approximately 600 millimeters (or other fixed predetermined width) ultimately limits the storage capacity of the storage facility as a whole because there will be a maximum number of media libraries that the storage facility will be able to contain. Once at that limit, adding more media libraries to the storage facility is not possible and therefore not a route for increasing its capacity. Instead, in order to increase the storage capacity of a storage facility, the storage capacity of individual media libraries has to be increased. Further, the limits to capacity similarly limit the throughput and efficiency of the media library by limiting the number of available media drives able to fit in the media library. As such, only a limited number of media drives can be used to read from and/or write to media cartridges at any given time. And, to this end, the inventors have developed a new type of media library which both: (i) has higher storage capacity and throughput than conventional media library systems; and (ii) conforms to sizing limitations that a storage facility may employ.

With respect to the limited throughput, conventional approaches to media library design employ a media drive system having a single column of media drives. In that way, all of the media drives in the media drive system are accessible to the robotic picker device at any given time. The robotic picker device can move media cartridges between the storage slots and any open media drive so that the media drive may perform its read or write operation on the media cartridges. This limits the number of media drives available in the media library to the number of media drives that fits in a single column. By limiting the number of media drives, the number of media cartridges from which data can be read and/or written to at any given time is similarly limited. To read data from more media cartridges, the media library would need to wait for the media drives to be finished with reading data from/writing data to their current media cartridges and then swap them out. Given the sizing constraints set by the storage facilities, the number of media drives in a single column may not be increased past a certain number, and thus, the efficiency and throughput of the conventional media library is limited by how many media drives can fit in a single column. Further, adding a second column of media drives that is accessible to the robotic picker device at the same time as the first column would require widening the footprint of the media library, or reduce the amount of available storage space in the media library.

To address some of the aforementioned problems with increasing the efficiency and throughput of a media library, the inventors have developed a new type of media library that has an increased throughput than conventional media library designs while nonetheless conforming to sizing requirements of storage facilities. The media library utilizes a dual- or multi-column media drive system rather than a single column of media drives. However, rather than making both or all columns accessible at the same time, only one column of the multiple columns may be accessible to the robotic picker device at any given time. Further, the media drives of the media drive system may be movable among various positions within the media drive system so that the media drives can be moved in and out of the accessible column as needed. As such, when a particular media drive is not in use, or is performing a read or write operation, the particular media drive may be moved to an inaccessible position (e.g., behind the storage areas) so that other media drives can be moved to the accessible column for media cartridge insertion or retrieval.

Accordingly, some embodiments provide for a media library system comprising: (a) a frame (e.g., having a width of 600 millimeters); (b) a media storage portion supported by the frame, the media storage portion comprising a plurality of storage slots configured to hold a respective plurality of media cartridges (e.g., tape cartridges) therein; (c) a media drive portion supported by the frame, the media drive portion comprising a plurality of moveable drives (e.g., moveable tape drives) physically arranged in two or more columns of drives (e.g., a first column in a first position and a second column in a second position), each particular drive of one or more of the plurality of moveable drives being configured to read data from a media cartridge when the media cartridge is inserted into the particular drive, and wherein the moveable drives are configured to be moved between a plurality of positions in the media drive portion; and (d) a robotic picker device configured to selectively retrieve a media cartridge from a storage slot in the media storage portion and place the media cartridge into one of the plurality of moveable drives.

In some embodiments, the media library system further comprises a controller configured to: (i) identify one or more moveable drives in the first set to be moved; (ii) cause movement of the one or more identified moveable drives (e.g., individually, as a subset of moveable drives, or as an entire column) out of the first column to provide a space in the first column (e.g. via a movement apparatus such as a stepper motor, moveable belt, or mechanical pusher); and (iii) cause movement of one or more moveable drives in the second set out of the second column and into the space in the first column. The controller may determine which of the media drives should be placed in the accessible column at any given time so that the media library system may facilitate efficient access to any of the media drives in the various positions of the media drive system.

In some embodiments, the media storage portion comprises a plurality of storage magazines (e.g. retained in magazine openings of the frame) each having multiple media storage slots (e.g., dual-cartridge storage slots) configured to hold at least one media cartridge.

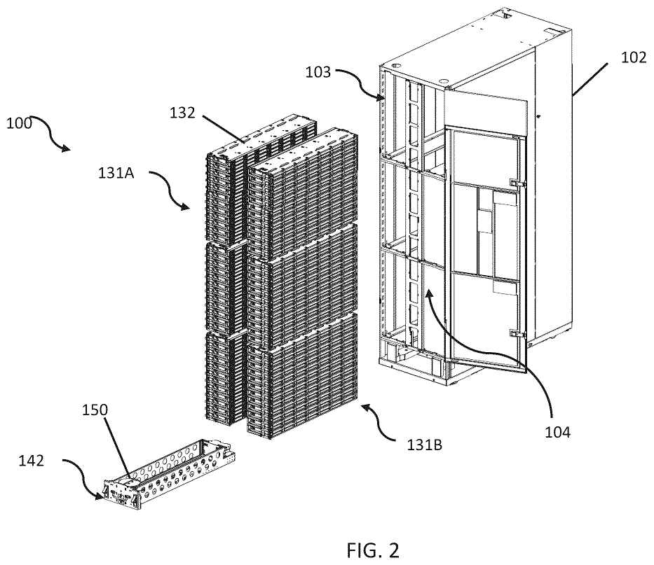

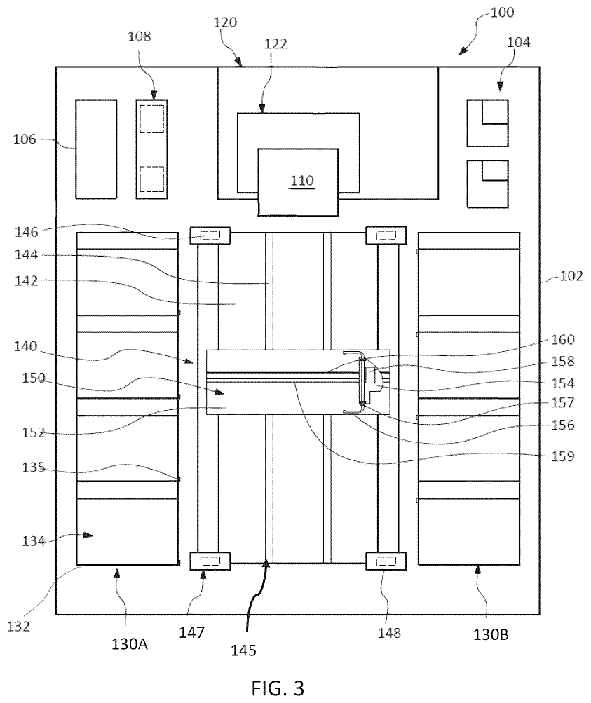

In some embodiments, the robotic picker device is configured to move in an interior space (e.g., interior space 104 of FIGS. 2 and 3) of the media library (e.g., between the first and second columns of media cartridge storage magazines), and (i) openings of storage slots in the media storage portion, through which media cartridges pass during retrieval or placement in the storage slots, are accessible by the robotic picker device in the interior space; (ii) openings of the moveable drives in the first column, through which media cartridges pass during retrieval or placement in the moveable drives, are accessible by the robotic picker device in the interior space; and (iii) openings of the moveable drives in the second column, through which media cartridges pass during retrieval or placement in the moveable drives, are not accessible by the robotic picker device in the interior space (e.g., as blocked by the media storage portion).

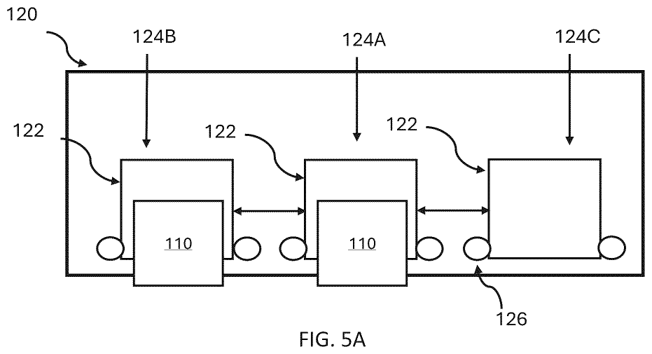

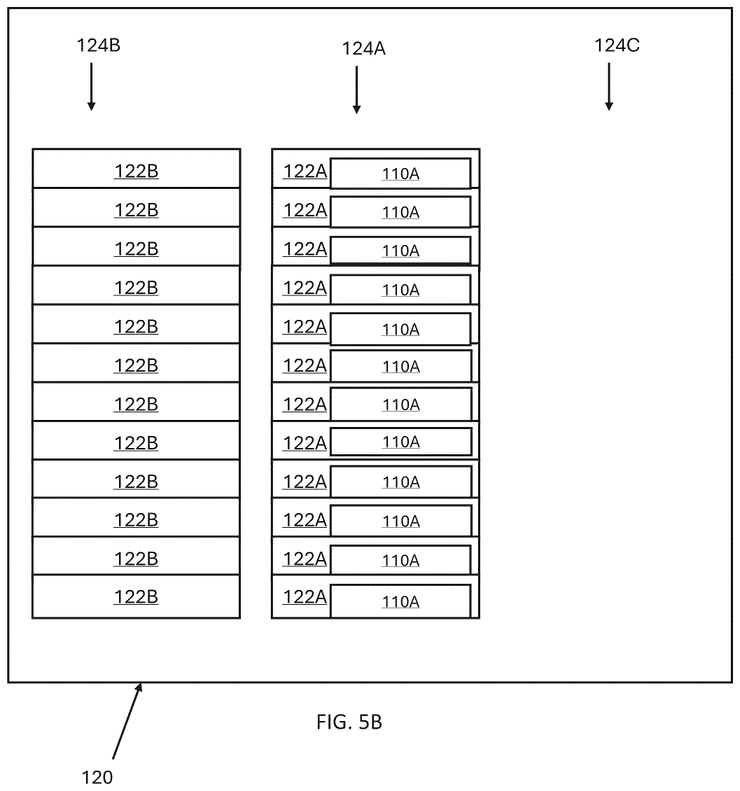

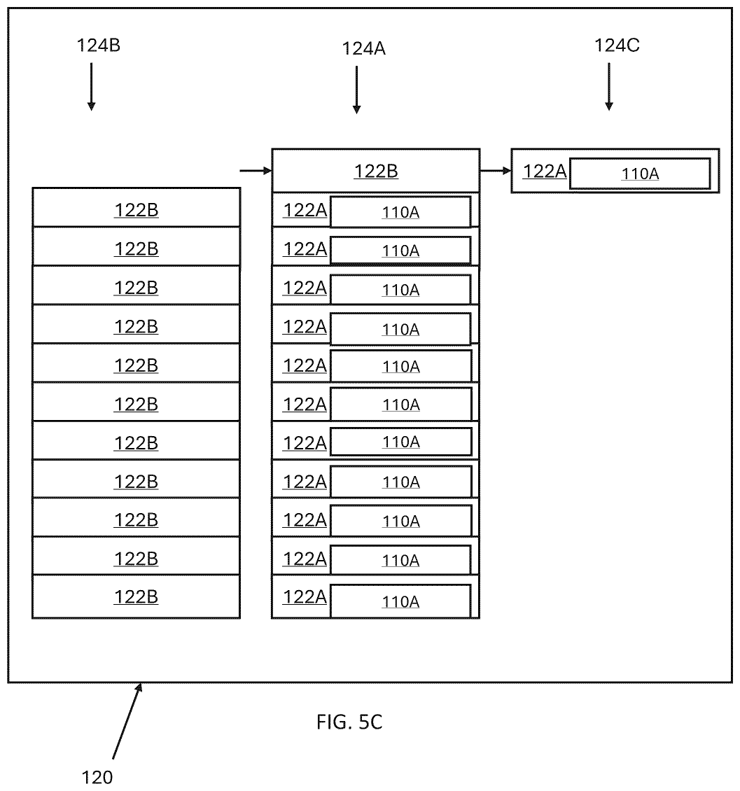

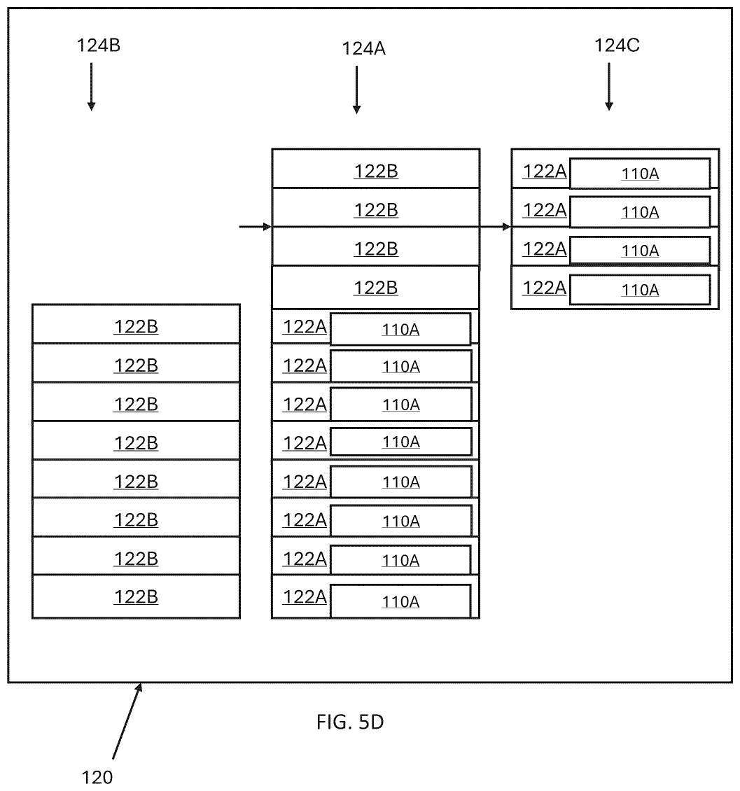

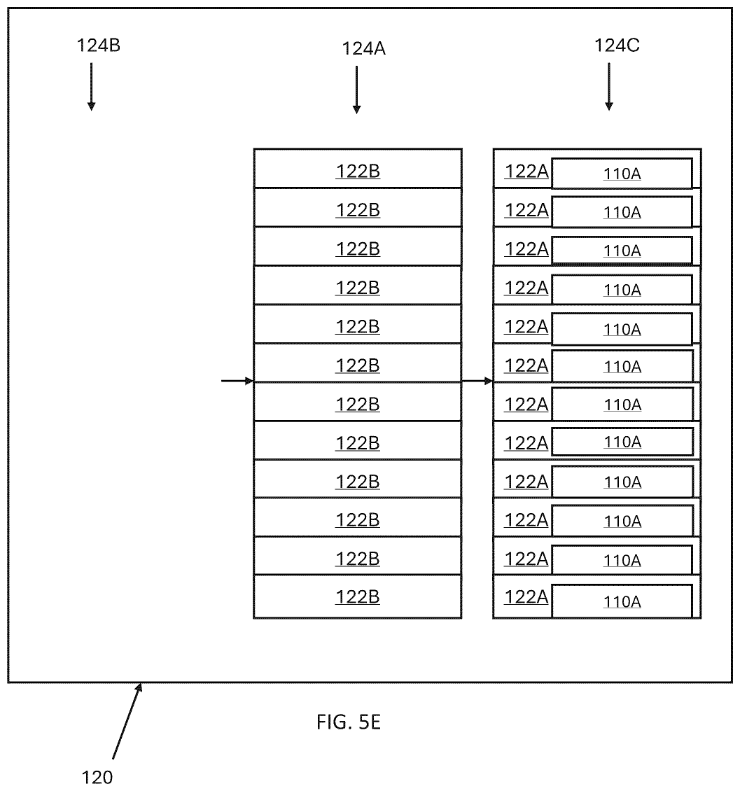

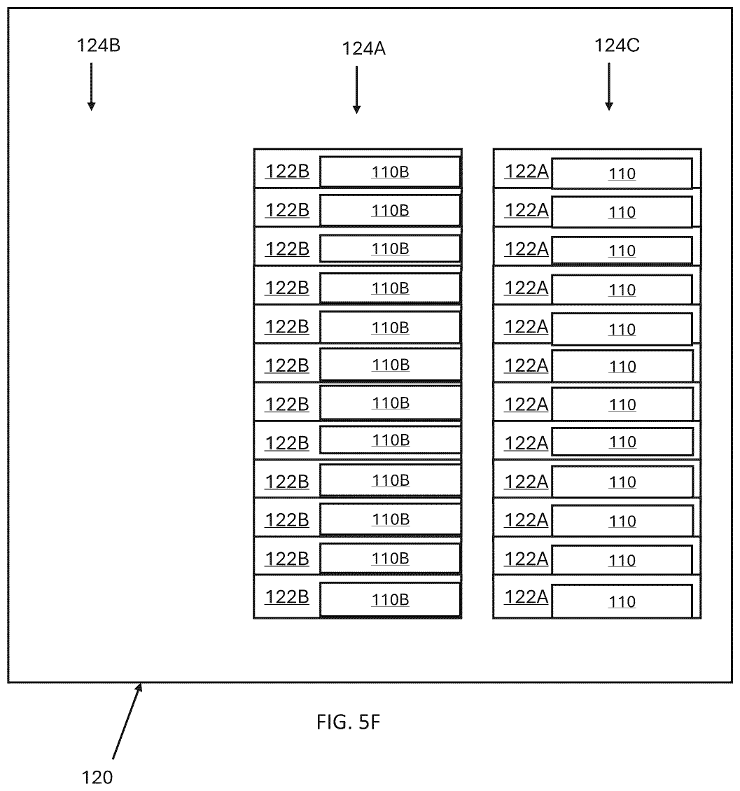

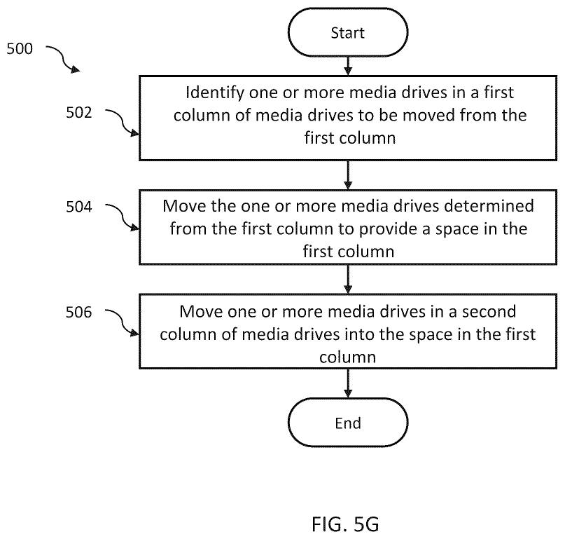

Some embodiments provide for a method (e.g., as described with respect to FIG. 5F) performed by a media library system, the media library system comprising a plurality of storage slots configured to receive media cartridges, a plurality of moveable drives arranged in two or more columns including a first column having moveable drives in a first position and a second column having moveable drives in a second position, a robotic picker device, and a controller. The method comprises causing the controller to perform: (i) identifying one or more moveable drives in the first column to be moved (e.g., by receiving information indicative of whether a media drive is occupied by a media cartridge); (ii) causing movement (e.g., individually, as a subset of moveable drives, as an entire column) of the identified one or more moveable drives out of the first column to provide a space in the first column (e.g., by controlling a movement apparatus); and (iii) causing movement of one or more moveable drives out of the second column and into the space in the first column.

It should be appreciated that the embodiments described herein may be implemented in any numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect.

Some embodiments described herein address all the above-described issues that the inventors have recognized with conventional media library systems. However, it should be appreciated that not every embodiment described herein addresses every one of these issues. It should also be appreciated that embodiments of the technology described herein may be used for purposes other than addressing the above discussed problems with conventional media library systems.

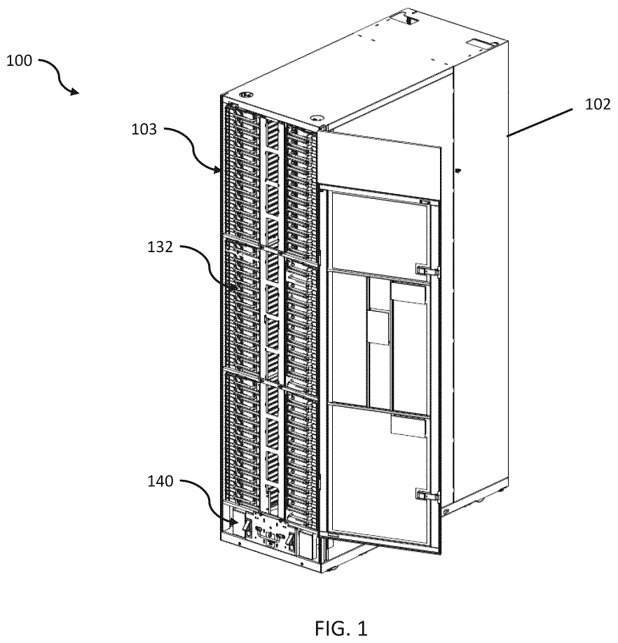

FIG. 1 depicts an example media library system 100, according to some embodiments. The media library system 100 includes a frame 102 having a plurality of magazine openings 103, a plurality of media cartridge storage magazines 132 in the plurality of magazine openings, and a media retrieval assembly 150. Media library system 100 may further include a media drive system (not pictured) supported by frame 102, having one or more media drives configured to read data from and write data to the storage medium of the media cartridges stored in the media library. As discussed above, the frame 102 may be of a particular size to be stored within a particular storage facility according to the sizing limitations of the particular storage facility. For example, frame 102 may have a particular width to fit according to the storage facility's standards. In some embodiments, the width of frame 102 may be 600 millimeters. However, the technology is not limited in that respect, and the width may vary depending on the size standards of the particular storage facility. For example, in some embodiments the width of frame 102 may be approximately 200 mm, 400 mm, 600 mm, 800 mm, 1000 mm, or any other suitable width, In some embodiments, the width of frame 102 may be between 200 mm-600 mm, 400 mm-600 mm, 600 mm-1000 mm, or within any suitable range.

FIG. 2 depicts an exploded perspective view of the example media library system 100 of FIG. 1, according to some embodiments. Frame 102 has a plurality of magazine openings 103 configured to receive a plurality of media cartridge storage magazines 132 for storage and use in the media library system. The magazine openings 103 may extend from a front end to a back end of frame 102 so that the media cartridge storage magazines may be received into magazine openings 103. In some embodiments, each magazine opening 103 may be configured to receive a respective media cartridge storage magazine 132. In other embodiments, each magazine opening 103 may receive two or more media cartridge storage magazines 132. In some embodiments, frame 102 may house the media drive system at the rear end of frame 102 so that magazine openings 103 may extend from the front end of frame 102 to the media drive system.

Magazine openings 103 may include one or more attachment or mounting features (not pictured) for securing the media cartridge storage magazines 132 into the openings, the attachment or mounting features at least partially defining the boundaries of each magazine opening 103. However, to increase available storage space and usable width within the interior of the media library, in some embodiments, magazine openings 103 may not include any attachment or mounting features and the media cartridge storage magazines 132 may be configured to be stacked on top of other media cartridge storage magazines 132 within the magazine openings 103. As such, media cartridge storage magazines 132 may be arranged in columns. For example, as depicted in FIG. 2, media cartridge storage magazines 132 are arranged in a first column 131A and a second column 131B. However, any suitable configuration of media cartridge storage magazines may be employed for storing media cartridges in the media library. Media cartridge storage magazines 132 may have a plurality of media cartridge storage slots configured in any suitable manner to receive and storage one or more media cartridges in the media library, details of which will be described further herein.

Media library 100 further includes a media retrieval assembly 140 for facilitating one or more functions of media library 100. For example, media retrieval assembly 140 may be configured to retrieve one or more media cartridges from media cartridge storage magazines 132 and move the retrieved media cartridge to one of the media drives in the media drive system, and vice versa. In some embodiments, retrieval assembly 140 includes a movable robotic picker device 150, and related assembly support structures such as assembly base 142, one or more support racks, one or more guide rails, or any other suitable support structures, details of which will be described further herein. Robotic picker device 150 may be configured to move in an interior space 104 of frame 102 to move one or more media cartridges to and from the media cartridge storage slots of media cartridge magazines 132 and one or more media drives of the media drives system. In some embodiments, robotic picker device 150 may be configured to move laterally, longitudinally, and/or vertically so that it may access and retrieve media cartridges from any media cartridge storage slot in the library. In some embodiments, at least a portion (e.g., a head portion) of robotic picker device 150 may be rotatable so that it may access and retrieve media cartridges from both column 131A and 131B, as well as rotate to face the media drive system to insert or retrieve a media cartridge in a media drive of the drive system.

FIG. 3 is a block diagram showing a top view of an example media library system 100 of FIG. 1 for storing one or more media cartridges 110, according to some embodiments. As illustrated, media library system 100 includes frame 102 for supporting one or more other components of media library system 100, media drive system 120, media storage area(s) 130, and media retrieval assembly 140. Although an example layout is illustrated, it can be appreciated that media library system 100 may have any suitable design that is configured to store a plurality of media cartridges 110 and use one or more media drives 122 to read data from and write data to the plurality of media cartridges 110. In some embodiments, to fit within one or more size standards set by a particular storage facility, frame 102 may have one or more dimensions sized according to the size standards. For example, frame 102 may have a particular width set by a particular storage facility (e.g., a width of 600 millimeters). In some embodiments, frame 102 may be rigid and may be at least substantially rectangular in shape, although the technology is not limited in this respect. Frame 102 may be constructed of any number of conventional materials, such as those utilized in industry standard rack mount cabinets.

Media library system 100 includes one or more media storage areas 130 (e.g., media storage areas 130A and 130B) for storing one or more media cartridges 110. Media storage areas 130 may include one or more media cartridge storage magazines 132. The storage magazines 132 may be arranged in one or more columns in storage areas 130. For example, a first column of storage magazines 132 may be disposed in a first storage area 130A and a second column of storage magazines 132 may be disposed in a second storage area 130B, although any suitable arrangement may be used as the technology is not limited in this respect.

Each storage magazine 132 includes one or more media cartridge storage slot 134 for retaining one or more media cartridges 110. The media cartridges 110 may have any suitable design and storage slots 134 may be configured to store the media cartridges 110 of a particular shape, or of multiple different shapes. For example, in some embodiments, the media cartridge 20 can be substantially rectangular box-shaped and storage slots 134. Although four storage slots 134 per storage magazine 132 are illustrated, the technology is not limited in this respect and each storage magazine 132 may have any suitable number of storage slots 134. Each storage slot 134 may be configured to receive and retain a single media cartridge 110. To increase the capacity of the media library, in some embodiments, each storage slot 134 may be configured to receive and retain more than one media cartridge 110 and may arrange the more than one media cartridges 110 in any suitable manner. Each storage slot 134 may include one or more features configured to retain and secure the one or more media cartridges 110 in the slot and facilitate retrieval functions of the media library, including for example, latch 135 and a spring-loaded mechanism (not pictured).

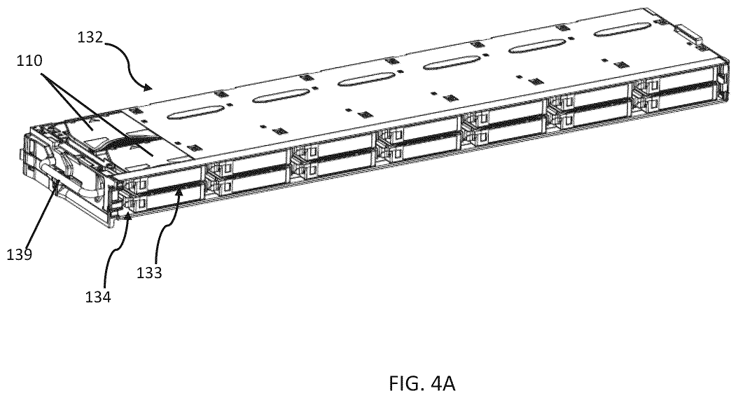

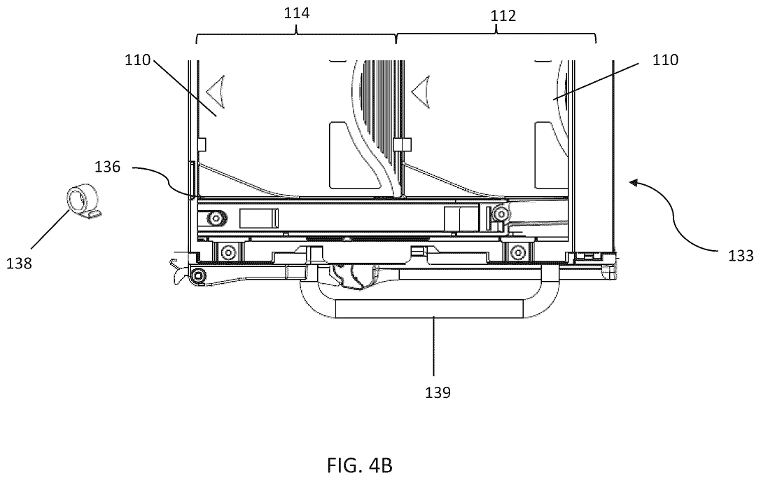

FIG. 4A depicts a perspective view of an example media cartridge storage magazine 132 for use in a media library system, according to some embodiments. Storage magazine 132 includes one or more media cartridge storage slots 134, openings 133, and a handle 139. Handle 139 may be used to insert or retrieve storage magazine 132 from the media library. In the embodiment depicted in FIG. 4, each storage slot 134 is configured to retain more than one media cartridge 110 in the media library. For example, storage slot 134 has a first row having two media cartridges 110 and a second row having another two media cartridges 110 disposed on top of the first row. However, the technology is not limited in this manner and each storage slot may only have one cartridge or more than two cartridges, or may be configured in any other suitable manner.

FIG. 4B depicts a cross-sectional view of a portion of an example media cartridge storage magazine 132 of FIG. 4, according to some embodiments. In each row of storage slot 134, one media cartridge 110 is disposed in a first portion 112 and a second media cartridge 110 is disposed in a second portion 114. The first portion 112 of storage slot 134 may be adjacent the opening 133 which is configured to allow access to storage slot 134. The second portion 114 may be a rear portion of storage slot 134 and the second media cartridge 110 may abut a rear wall of storage magazine 132.

The second portion 114 may be accessible through the opening 133 and through the first portion 112 so that a media cartridge 110 being inserted into or retrieved from the second portion 114 may pass through opening 133 and first portion 112. Upon retrieval by a retrieval assembly, the retrieval assembly may reach through opening 133 and first portion 112 to retrieve the second media cartridge 110 from second portion 114. Additionally or alternatively, each storage slot 134 may include a spring-loaded mechanism 136 having spring 138. Spring-loaded mechanism 136 may be configured to bias the second media cartridge 110 stored in the second portion 114 towards first portion 112 and opening 133. In that way, when first portion 112 is empty, spring-loaded mechanism 136 may push the second media cartridge 110 at least partially into first portion 112 for easier retrieval. For example, spring-loaded mechanism 136 may be shaped (e.g., substantially triangularly) to abut a slanted portion in the rear of media cartridge 110, and may provide a biasing force to the slanted portion towards the first portion 112 and opening 133, although the spring-loaded mechanism 136 and the media cartridge 110 may be otherwise shaped or configured to engage in a similar manner. It can be appreciated that storage magazines 132 and storage slots 134 may be configured in any other suitable manner, with any modifications to the designs described herein. For example, in some embodiments, each storage slot may only include one row of media cartridges (rather than two or more stacked rows). In other embodiments, the second portion 114 may not be the most rearward portion, and storage slot 134 may include a third (or more) portions disposed between the second portion 114 and the rear wall of storage magazine 132.

Returning to FIG. 3, media library system 100 includes at least one media drive system 120. Media drive system 120 may include one or more media drives 122. The one or more media drives 122 may be configured for reading and/or writing data with respect to the media cartridge 110. The one or more media drives 122 may be arranged in one or more columns in a particular area of the media library system 100 (e.g., a rear portion). The number of media drives 122 provided within the media library system 100 can be varied to suit the specific attributes (e.g., dimensions, media cartridge type, etc.) of media library system 100. For example, in certain embodiments, the media library system 100 can include three media drives 122 that are stacked substantially one on top of another with no or minimal spacing therebetween. Alternatively, the media library system 100 can include greater than three or fewer than three media drives 122 and/or the media drives 122 can be positioned in a different manner relative to one another. For example, in certain non-exclusive alternative embodiments, the media library system 100 can be configured to include one hundred or more media drives 122. Still alternatively, depending on the design of the media library system 100, the media drives 122 can be adapted for use with different types of media, such as tape cartridges, optical drives, hard disk drives, etc.

In certain embodiments, the media library system 100 may include more than a single media drive system 120 for purposes of providing the one or more media drives 122. For example, in some embodiments, the media library system 100 can include a plurality of media drive systems 120, with each media drive system 120 including one or more individual media drives 122. In one embodiment, the media library system 100 can include three individual media drive systems 120, with each media drive system 120 including a single media drive 122, to provide a total of three media drives 122 for the media library 100. Alternatively, the media library system 100 can include any desired number of media drive systems 120 and/or media drives 122.

As noted above, media drive system 120 may include one column of media drives. However, to increase the throughput of the media library system while adhering to dimensional requirements set by particular storage facilities, the inventors have recognized the benefit of providing multiple columns of media drives in media drive system 120. In those embodiments, the media drives are moveable drives which may be configured to move between two or more positions in media drive system 120. As such, only one column needs to be accessible to the robotic picker device, as media drives may be moved into and out of the accessible column as needed. By including more media drives in the media drive system 120, data from more media cartridges may be read from and/or written to concurrently (e.g., simultaneously), increasing the throughput and efficiency of the media library system 100.

FIG. 5A depicts a top view of an example multi-column media drive system 120 for use in a media library system, according to some embodiments. Media drive system 120 may have two or more positions for arranging media drives 122. Three positions 124A, 124B, and 124C have been illustrated in FIG. 5A, although media drive system 120 may have any suitable number of positions for arranging media drives 122. Further, although positions 124A, 124B, and 124C are arranged laterally along media drive system 120, any suitable arrangement may be used. For example, the positions may be arranged along a curved line, in an “L” formation, or another arrangement. In some embodiments, only media drives 122 in first position 124A may be accessible by the robotic picker device (e.g., robotic picker device 150) for inserting or retrieving media cartridges 110 from the media drive 122. For example, only media drives 122 in position 124A may have openings that face the interior space 104 in which robotic picker device 150 moves. However, by providing moveable drives, media drives 122 in second position 124B or third position 124C may be moved into first position 124A so that they may be accessible by robotic picker device 150.

As such, media drive system 120 includes a plurality of media drives 122 arranged in the three positions of media drive system 120. The media drives 122 are moveable drives configured to move between at least two of the three positions 124A, 124B, and 124C. For example, the moveable drives 122 may initially be arranged in a first column in first position 124A and a second column in second position 124B so that third position 124C may have open space to allow for movement of the moveable drives 122 out of the other two positions.

To facilitate the movement of the moveable drives 122, media drive system 120 includes one or more movement apparatuses 126 configured to move one or more of the moveable drives 122 between the various positions in media drive system 120. The movement apparatus(es) 126 may include any suitable movement apparatus, including but not limited to, stepper motors, moveable belts, and/or mechanical pushers. The movement apparatuses may be controlled by a controller of the media library system (e.g., controller 108). In some embodiments, each moveable drive 122 may have a respective movement apparatus 126. In that way, each moveable drive 122 may be moved individually. In some embodiments, a subset of the moveable drives 122 may have a respective movement apparatus 126 so that the subset may be moved as a whole. In yet other embodiments, an entire column of moveable drives 122 may have a single movement apparatus 126 so that the entire column may be moved at once. Additionally or alternatively, moveable drives 122 in adjacent columns may share a single movement apparatus 126 so that adjacent moveable drives 122 may be moved as one unit. For example, a moveable drive 122 in the first column may share a movement apparatus 126 with an adjacent moveable drive 122 in the second column so that the two moveable drives 122 may move as one unit.

FIG. 5B depicts a front view of an example multi-column media drives system 120 for use in a media library system having moveable drives in a first arrangement, according to some embodiments. As noted above, moveable drives 122 may initially be arranged in two columns. For example, moveable drives 122A are arranged in a first column in first position 124A, and moveable drives 122B are arranged in a second column in second position 124B. In that way, third position 124C may provide open space to facilitate movement of moveable drives 122A out of the first column and allow moveable drives 112B to be moved from the second column into the first column so as to be accessible to the robotic picker device of the media library system.

Initially, only moveable drives 122A may be accessible to the robotic picker device for inserting or retrieving media cartridges 110 (e.g., 110A) from the drives. Once media cartridges 110A have been inserted into (or retrieved from) moveable drives 122A, moveable drives 122A may be moved via movement apparatus(es) 126 (not pictured) out of the first position 124A. In some embodiments, moveable drives 122A may be moved out of first position 124A when the media cartridge 110A is inserted into the moveable drive 122A. For example, the controller (e.g., controller 108) may receive information indicating that a first media cartridge 110A has been inserted into a first moveable drive 122A, and the controller may cause the movement apparatus 126 associated with first moveable drive 122A to move first moveable drive 122A out of the first column in first position 124A. In that way, space is created in the first column to allow for a first moveable drive 122B to be moved into the first column in position 124A from the second column in position 124B. Additionally or alternatively, first moveable drive 122A may only be moved out of the first column when respective media cartridges 110A have been inserted into all of a subset of the moveable drives 122A or the entire first column of moveable drives 122A.

FIG. 5C depicts a front view of the example multi-column media drive system of FIG. 5B having moved a moveable drive out of the first column to create a space and moving another drive from the second column into the space created in the first column, according to some embodiments. As illustrated, the first moveable drive 122A having media cartridge 110A inserted is moved out of the first column in first position 124A and is moved into the third position 124C, for example, by a movement apparatus controlled as described above. However, the technology is not limited in this respect and the first media drive 122A may be moved to any suitable position in media drive system 120. Having moved first media drive 122A out of the first column, a space is available for a first media drive 122B in the second column to be moved into the first column. As such, the first media drive 122B in the second column may be subsequently moved into the space, or may be moved substantially simultaneously with first media drive 122A. When moved into the first column in first position 124A, first moveable drive 122B may now be accessible to the robotic picker device to insert (or retrieve) a media cartridge 110 into the first moveable drive 122B.

To facilitate support and allow movement, each position may include a column support structure (not pictured) so that any of the moveable drives in each column or position may be moved between positions and still maintain structural support for each of the moveable drives. Additionally or alternatively, rather than individual support structures for each position, the support structure may span all of the positions in the media drive system 120 to support moveable drives in any of the positions.

Alternatively, as mentioned above, rather than moving each moveable drive individually, in some embodiments a subset of the moveable drives in each column may be moved as a unit. FIG. 5D depicts a front view of the example multi-column media drive system of FIG. 5B having moved a subset of moveable drives out of the first column to create a space and moving another subset of drives from the second column into the space created in the first column, according to some embodiments. As with FIG. 5C, having inserted respective media cartridges 110A in each of the four moveable drives 122A in the illustrated subset, the controller may cause movement apparatus (not pictured) to move the subset of four moveable drives 122A out of the first column in first position 124A. As illustrated, the four moveable drives 122A may be moved to third position 124C. Having created a space in the first column for four additional moveable drives, the controller may subsequently (or substantially simultaneously) cause the movement apparatus to move four moveable drives 122B from the second column to the space in the first column. Now being in the first position, the four moveable drives 122B are accessible by the robotic picker device. While four moveable drives are illustrated as being part of the subset, it can be appreciated that any number of moveable drives in a column may make up a subset (e.g., 2, 4, 5, 10, 20, etc.).

Alternatively, as mentioned above, the moveable drives may be moved as an entire column. FIG. 5E depicts a front view of the example multi-column media drive system of FIG. 5B having moved all drives out of the first column to create a space and moving all drives in the second column into the space created, according to some embodiments. As with FIGS. 5C and 5D, having inserted respective media cartridges 110 into each of the moveable drives 122A in the first column, the controller may cause the movement apparatus to move the entire column of moveable drives 122A out of the first position 124A (e.g., to third position 124C). The second column of moveable drives 122B may be subsequently (or substantially simultaneously) moved from the second position 124B to first position 124A to be accessible by the robotic picker device. Having moved the moveable drives 122B into the first position to be accessible by the robotic picker device, respective media cartridges 110B may be inserted into toe moveable drives 122B for reading or writing data, as depicted in FIG. 5F.

The moveable drives 122A and 122B may be moved among the various positions as needed. For example, when a moveable drive 122A in the third position 124C is done reading or writing data to respective media cartridge 110A, the controller may be configured to cause the movement apparatus to move an adjacent moveable drive 122B out of the first position 124A to provide space for the finished moveable drive 122A to be moved into the first position. In that way, the respective media cartridge 110A may be retrieved and replaced back into its respective storage slot. Additionally or alternatively, moveable drives 122A and 122B may be moved to the second and third positions when the robotic picker device does not need to access the moveable drives (e.g., the moveable drive is not in use, or is in the process of reading or writing data). In that way, the first position 124A may have open space for any of the moveable drives 122A and 122B to be moved into the first position 124A as needed without the need to first move another moveable drive out of the way.

FIG. 5G is a flow chart for an example process 500 of moving one or more moveable drives between a plurality of positions in a media drive system, according to some embodiments. In some embodiments, a controller integrated with the media library system (e.g., controller 108) may be configured to perform process 500. Process 500 begins, at step 502, by identifying one or more media drives in the first column of media drives (e.g., moveable drives 122A) to be moved from the first column. As discussed above, an individual media drive, a subset of media drives, and/or an entire column of media drives may be identified to be moved. In some embodiments, the controller identify the one or more media drives to be moved by first receiving information indicative of whether one or more media drives in the first column are occupied by a respective media cartridge stored in the media library. The information may be received at any suitable time. For example, the controller may receive the information as soon as the media cartridge is inserted into a media drive in the first column. The information may be stored in a memory storage (e.g., memory 904) for use by the controller when process 500 is to be executed. In other examples, the controller may request the information and receive the information only when process 500 is to be executed.

In some embodiments, the controller may only identify media drives to be moved when all of the media drives in the first column in the first position have a respective media cartridge inserted. In that way, media drives in the first column are only moved when the first column is completely full. Alternatively or additionally, the controller may identify media drives to be moved whenever a media cartridge is inserted into the media drive or when a subset of media drives have media cartridges inserted. In that way, the available space in the first column may be maximized to facilitate efficient insertion of additional media cartridges without having to move the media drives to create an available space.

In some embodiments, the controller may receive other information for use in identifying the one or more media drives in the first media drive to be moved. For example, a media drive in the second position or third position (e.g., positions 124B or 124C) may be finished with its read or write function. Since the second and third positions are inaccessible to the robotic picker device, the finished media drives would need to be moved to the first column in the first position so that the media cartridge may be retrieved and returned to its respective storage slot. As such, the information may indicate whether a particular media drive is still performing its read or write function and may identify the media drive in the first column that is adjacent to a finished media drive to be moved, Identifying the one or more media drives to be moved may involve determining that the adjacent media drive in the second column is finished with its read or write operation. Further, the information may indicate whether the media drive in the second column adjacent to a media drive in the first column has a media cartridge inserted. As such, identifying the one or more media drives in the first column may involve determining that the adjacent media drive in the second column does not have a media cartridge inserted.

Having identified one or more media drives to be moved, process 500 then proceeds, at step 504, to move the identified one or more media drives from the first column to provide a space in the first column. As described above, the media drive system may include one or more movement apparatuses configured to move the media drives between positions. The controller may control the one or more movement apparatuses associated with the identified one or more media drives to move the media drives out of the first column. The identified one or more media drives may be moved individually, as a subset of media drives, or as an entire column. In moving the identified one or more media drives, a space may be provided in the first column (and first position) to allow for additional media drives to be moved into the space in the first column.

After the identified one or more media drives are moved from the first column to provide a space, process 500 proceeds at step 506 to move one or more media drives in a second column of media drives into the space in the first column. In some embodiments, this may comprise moving the media drive(s) in the second column that are adjacent to the media drive(s) in the first column that were moved at step 504. In some embodiments, any empty media drive in the second column may be moved into the space in the first column. As such, the media drives moved into the first column may be accessible to the robotic picker. As with step 504, the controller may control the one or more movement apparatuses associated with the media drive(s) in the second column to move the media drive(s) into the space in the first column.

As described above with respect to FIGS. 5B-F, process 500 may be used to move one or more media cartridges between positions in the media drive system for any suitable reason. For example, process 500 may be used to move occupied media drives out of the first column to provide space for empty media drives to allow for more media cartridges to be inserted. In other examples, process 500 may be used to move an occupied media drive back into the first column once the read or write process is completed so that the robotic picker device may retrieve and return the media cartridge to its respective storage slot.

Returning to FIG. 3, media library system 100 includes one or more retrieval assemblies 140 for supporting components that facilitates one or more functions of the media library (e.g., cartridge retrieval). The media retrieval assembly 140 includes an assembly base 142, an assembly guide system 144, an assembly mover system 146, and/or rack assembly 147 for support the media retrieval assembly 140. Media retrieval assembly 140 may be configured to support and facilitate movement of one or more media cartridges 110 throughout the media library system 100 as described herein using robotic picker device 150. As such, retrieval assembly 140 may be positioned in an interior space 104 of media library system 100 so as to provide robotic picker device 150 access to all of the storage slots 134 and media drives 122 in media library system 100. For example, in the illustrated embodiment having two media storage areas 130 disposed on either side of the media library system 100, retrieval assembly 140 may be disposed in a central portion between each media storage area 130 so that robotic picker device 150 may move in the interior space 104 to access media cartridges 110 in each storage slot 134.

In some embodiments, the assembly base 142 may be initially disposed at a bottom of frame 102 of the media library (e.g., as illustrated in FIGS. 1 and 2). In that way, the assembly base 142 may provide support for the robotic picker device 150 as the picker system 150 accesses the media cartridges 110 and moves the media cartridges 110 between the storage slots 134 and the media drives 122. In some embodiments, the assembly base 142 can be a substantially rectangular-shaped plate that is coupled to each of the racks 148 of the rack assembly 147. Alternatively, the assembly base 24A can have another suitable design.

The assembly guide system 144 may be configured to guide movement of the robotic picker device 150 as the picker system 150 moves along the assembly base 142. In some embodiments, as shown, the assembly guide system 144 can include a pair of guide rails 145 that guide the movement of the robotic picker device 150 longitudinally along the assembly base 142. Alternatively or additionally, the assembly guide system 144 may include guide rails perpendicular to guide rails 145 for supporting lateral movement (e.g., between the two media storage areas 130).

The assembly mover system 146 may be configured to move the assembly base 142 along the racks 148 of the rack assembly 147 so as to vertically position the robotic picker device 150 relative to the storage slots 134 and/or the media drives 122. In some embodiments, the assembly mover system 146 can include four individual movers, with one mover being secured to, integrated with, and/or positioned adjacent to each of the corners of the assembly base 142 and also positioned adjacent to one of the racks 148 of the rack assembly 147. In that way, the assembly mover system 146 can maintain the assembly base 142 in a level, horizontal position as the assembly base 142 is moved vertically up and down along the racks 148 of the rack assembly 147. The movers of assembly mover system 146 may include any suitable movement apparatus including, but not limited to, motors, pulleys, belts, or any other suitable movers.

The robotic picker device 150, as noted, may be configured to selectively access the media cartridges 110 and move the media cartridges 110 between the storage slots 134 and the media drives 122. In some embodiments, the retrieval assembly 140 including robotic picker device 150 enables quick and easy retrieval of media cartridge 110 from a storage slot 134. More particularly, in some embodiments, the robotic picker device 150 may include a picker head 152 having one or more slots for receiving a media cartridge 110, one or more picker fingers 156 movable coupled to picker head 152 (e.g. via reach carriage 154) and configured to selectively grasp one of the one or more media cartridges 110, latch deactivator 157 for deactivating latch 135 of storage slot 134 in which the media cartridge 110 is retained, and/or reach motor 158 for moving the picker fingers 156 towards storage slot 134. In some embodiments, latch deactivator 157 may be coupled to or integrally formed with one or both of picker fingers 156, and any other suitable portion of the robotic picker device 150.

During use of the media library system 100, the retrieval assembly 24, such as upon request of a user or host, may be moved toward a particular storage slot 134 for purposes of retrieving a media cartridge 110 therefrom, such as during a process of performing a designated or requested read/write operation. For example, assembly mover system 146 may move the robotic picker device 150 along racks 148 and guide rails 145 so that a slot of picker head 152 is aligned with an opening of the storage slot 134 (e.g., opening 133). Once the robotic picker device 150 is appropriately positioned generally adjacent to the particular storage slot 134, the picker fingers 156 may be moved along guide rails 160 with reach motor 158 relative to the picker head 152 from a retracted position, where the picker fingers 156 are not positioned near the particular storage slot 134, to a first extended position, where the picker fingers 156 are positioned near the particular storage slot 134 but cannot yet grasp the media cartridge 110 retained within the particular storage slot 134. When the picker fingers 156 are so positioned near the particular storage slot 134 in the first extended position, the picker fingers 156 can be moved from a first (closed) position to a second (open) position.

Once the picker fingers 156 have been moved to the second (open) position, the robotic picker device 150 may further move the picker fingers 156 (e.g., with reach motor 158) from the first extended position to a second extended position so that the picker fingers 156 are positioned directly adjacent to the particular storage slot 134 and/or the media cartridge 110. With the picker fingers 156 positioned in the second extended position directly adjacent to the storage slot 134, the picker fingers 156 can then be moved into a third (engaged) position and gradually engage opposing sides of the media cartridge 110.

As the picker fingers 156 are being moved to the third (engaged) position, the latch deactivator 157 may gradually push the latch 135 into a deactivated position so that the media cartridge 110 can be accessed and removed from the particular storage slot 134. In the deactivated position, latch 135 may be moved so that it is no longer blocking removal of the media cartridge 110 from the storage slot 134. In certain embodiments, movement of the latch 19 between the activated position and the deactivated position entails rotational movement of the latch 135 so that latch 135 is no longer blocking removal of media cartridge 110. It can be appreciated that in some embodiments having a dual- or multi-cartridge storage slot 134, media cartridges 110 stored in the second portion (or third, or fourth, etc.) position may not be directly adjacent the opening 133 of storage slot 134. As such, the various positions described above may be extended so that picker fingers 156 may extend deeper into storage slot 134 to be properly positioned adjacent the second media cartridges 110 for engagement and retrieval. Alternatively or additionally, after removal of the first media cartridge from the first portion of the storage slot 134, the spring-loaded mechanism 136 (e.g., as pictured in FIG. 5) may push the second media cartridge 110 at least partially into the first position. In that way, the various positions of robotic picker device 150 described above may not be extended to reach media cartridges in the second portion. It can be appreciated that retrieval assembly 140 and robotic picker device 150 may be configured to similarly re-insert the media cartridge 110 into the storage slot 134 (e.g., after the read/write operation is completed). The retrieval assembly 140 and robotic picker device 150 may re-insert the media cartridge 110 into storage slot 134 in a similar manner as described above. However, the sequence of positions described above may be reversed for inserting the media cartridge 110 into storage slot 134.

It can be appreciated that, when retrieving a media cartridge 110 from a rear portion of a storage slot 134 (e.g., second portion 114), the media cartridge 110 stored in a forward portion of the storage slot 134 (e.g., first portion 112) may be retrieved. In some embodiments, the robotic picker device 150 may include a single slot for receiving media cartridges. As such, the first media cartridge 110 may be moved to a separate storage location (e.g., an intermediary storage location or another storage slot 134) while the second media cartridge 110 is being retrieved. However, the inventors have recognized that it may be beneficial to provide a system for retrieving the media cartridge stored in the rear portion of the storage slot while minimizing any excess movement. As such, in some embodiments, the robotic picker device 150 for use in retrieval assembly 140 may be a dual-slot robotic picker device. In that way, the robotic picker device may retrieve the first media cartridge 110 and hold the first media cartridge in the first slot, while the second media cartridge 110 in the rear portion is being received and retained in the second slot of the dual-slot robotic picker device to minimize movement of the retrieval assembly between the storage slot 134 and any intermediary or other storage.

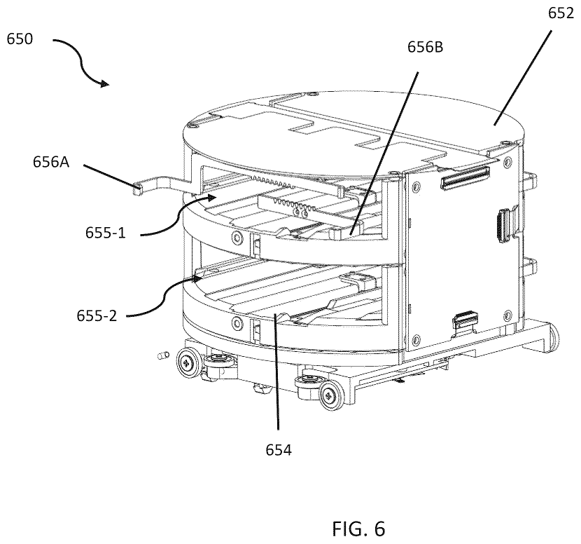

FIG. 6 depicts an example dual-slot robotic picker device 650 for use in a media library system, according to some embodiments. Dual-slot robotic picker device 650 includes a picker head 652 having two or more slots 655. In some embodiments, each slot 655 may include a reach carriage 654 and one or more picker fingers 656A and 656B. The reach carriage 654 and one or more picker fingers for each slot 655-1 and 655-2 may be operated in a similar manner as described above with respect to retrieval assembly 140 and robotic picker device 150. In some embodiments, the first slot 655-1 may be configured to retrieve and retain the media cartridge 110 from the first portion of the storage slot 134, whereas the second slot 655-2 may be configured to retrieve and retain the media cartridge 110 from the second portion of storage slot 134. As such, the reach carriage 654 and picker fingers 656A and 656B of the second slot may be configured to extend further into the storage slot 134 than the reach carriage 654 and picker fingers 656A and 656B of the first slot. In other embodiments, the dual-slot robotic picker device 650 may only have one set of a reach carriage 654 and picker fingers 656 that may be configured to retrieve both the first and second media cartridges from the storage slot 134 and insert them into their respective slots.

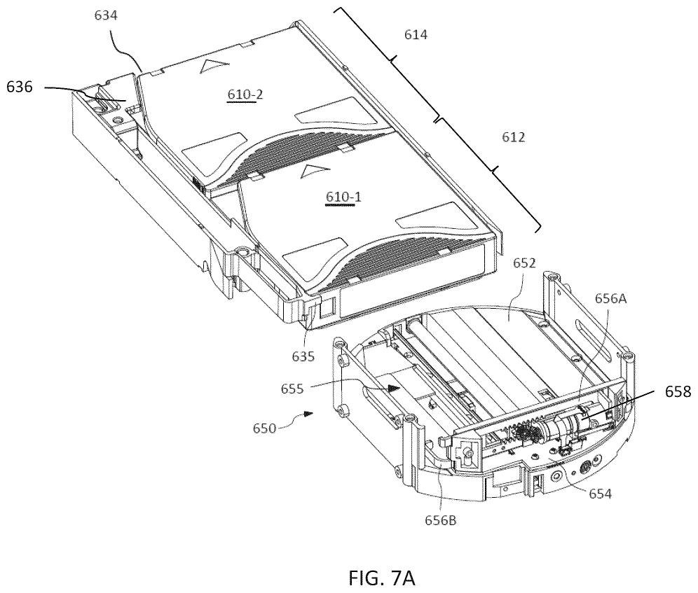

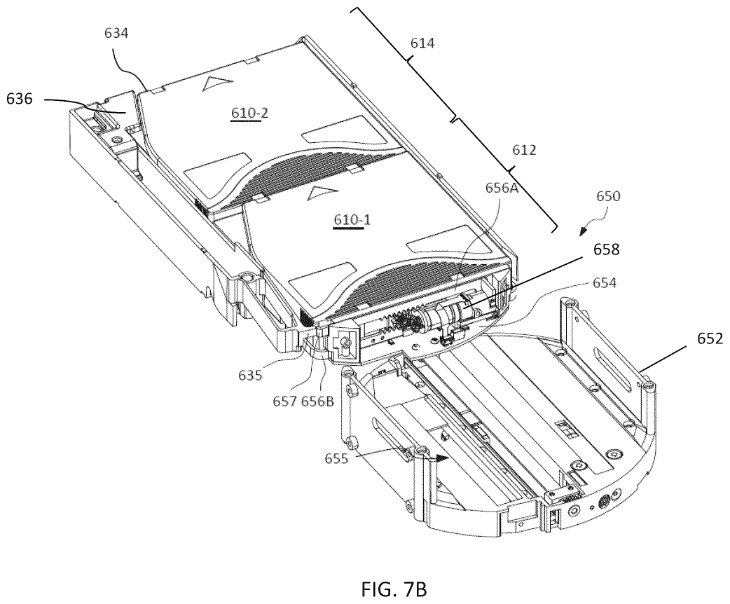

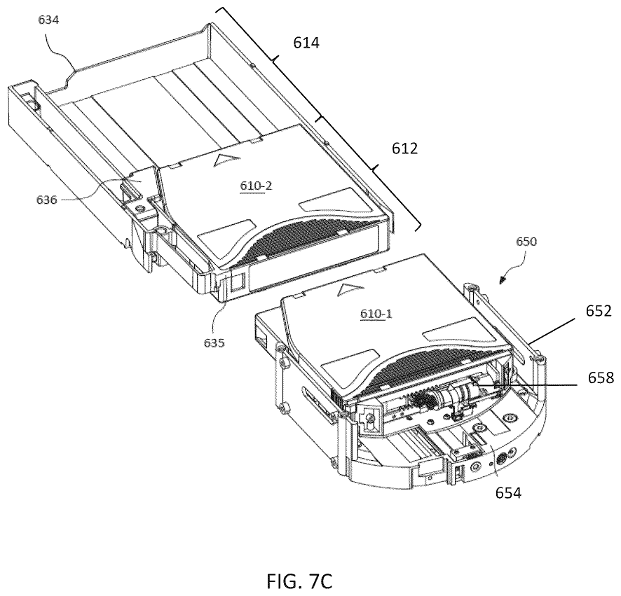

FIGS. 7A-7C depict various positions of the robotic picker device (e.g., picker device 650) retrieving a media cartridge 610 from a first portion 612 of a dual-cartridge storage slot 634. In the figures, the top portion of robotic picker device 650 has been removed for clarity and visibility.

FIG. 7A depicts a perspective view of a media cartridge storage slot and a robotic picker device in a first position with picker fingers in a closed position, according to some embodiments. In the first position, picker fingers 656A and 656B may be in a closed positioned and retained within slot 655 of picker head 652. For example, picker fingers 656A and 656B may be secured to reach carriage 654 which may, in the first position, be retained in slot 655. During retrieval of a media cartridge 610 from storage slot 634, picker fingers 656A and 656B may be moved from the closed position to an open position and reach carriage 654 may be moved at least partially out of slot 655 so that the picker fingers may engage media cartridge 610. For example, reach motor 658 may move reach carriage 654 along a guide rail (not pictured) of robotic picker device 650 towards storage slot 634.

While the robotic picker device 650 is in the first position, storage slot 634 may include latch 635 in an activated position on a first side of the storage slot 634 adjacent the robotic picker device 650 and a spring-loaded mechanism 636 disposed on a second side of storage 634 opposite the first side further from the robotic picker device 650. Spring-loaded mechanism 636 may be configured to bias the second media cartridge 610-2 stored in second portion 614 towards the first side of the storage slot 634. For example, spring-loaded mechanism 636 may engage with a portion of media cartridge 610-2 adjacent the second side with a biasing force. Being in the activated position, latch 635 may secure the media cartridges 610-1 and 610-2 from being pushed out of storage slot 634 due to the biasing force from spring-loaded mechanism 636.

FIG. 7B depicts a perspective view of a media cartridge storage slot and a robotic picker device in a second position with picker fingers engaged with a first media cartridge, according to some embodiments. In the second position, reach motor 658 has moved reach carriage 654 out of slot 655 and towards storage slot 634. In that way, picker fingers 656A and 656B may reach and engage with the first media cartridge 610-1 stored in the first portion 612 of storage slot 634. After being placed in the second position, picker fingers 656A and 656B may be moved from the open position to an engaged position to securely engage and grab first media cartridge 610-1.

In moving the reach carriage 654 and picker fingers 656A and 656B to the second position, latch deactivator 657—disposed on a first side of picker finger 656A in the illustrated embodiment—may engage with latch 635 to push latch 635 from the activated position to a deactivated position. Deactivating latch 635 may be done in any suitable manner. For example, in some embodiments, latch 635 and latch deactivator 657 may be shaped analogously so that, in moving the reach carriage 654 and picker fingers 656A and 656B to the second position, the latch deactivator 657 may engage with and slide against latch 635 so that latch 635 is pushed to the deactivated position. Additionally or alternatively, in some embodiments as in the illustrated embodiment, latch deactivator 657 may extend from a first side of a picker finger (e.g., picker finger 656A). Moving the picker finger 656A from an open position to an engaged position as described above may cause the latch deactivator 657 to push latch 635 from the activated position to the deactivated position so that media cartridge 610-1 may be retrieved. It can be appreciated that latch deactivator 657 may not be disposed on a picker finger 656A, and may be disposed on any portion of the robotic picker device 650 (e.g., reach carriage 654, picker finger 656B, etc.) that may allow latch deactivator 657 to engage with latch 635.

FIG. 7C depicts a perspective view of a media cartridge storage slot and a robotic picker device in a third position with the first media cartridge being received into a first slot of the robotic picker device, according to some embodiments. In the third position, reach motor 658 retracts reach carriage 654 back into slot 655 of robotic picker device 650. With picker fingers 656A and 656B in the engaged position, retracting reach carriage 658 back into slot 655 additionally pulls first media cartridge 610-1 into slot 655. In retracting reach carriage 654 and picker fingers 656A and 656B back into slot 655, latch deactivator 657 may disengage from latch 635. However, latch 635 may not immediately return to the activated position. Rather, an adjacent side of first media cartridge 610-1 may prevent latch 635 from returning to the activated position until media cartridge 610-1 is removed from storage slot 634. For example, latch 635 may slide along the adjacent side of media cartridge 610-1 as it is being retrieved. Media cartridge 610-1 may include a rearward slanted portion. When the latch 635 slides along the slanted portion of media cartridge 610-1, latch 635 may slowly be placed back into the activated position.

Additionally, in some embodiments, for example, embodiments with spring-loaded mechanism 636, retrieving first media cartridge 610-1 may cause second media cartridge 610-2 to be moved from second portion 614 at least partially to first portion 612. For example, spring-loaded mechanism 636 may push second media cartridge 610-2 towards first portion 612 as first media cartridge 610-1 is being removed. As the latch 635 is returned to the activated position via the slanted portion of first media-cartridge 610-1, latch 635 may engage with the second media cartridge 610-2 so that spring-loaded mechanism 636 does not push second media cartridge 610-2 out of storage slot 634. In that way, the second media cartridge 610-2 may be retrieved in a similar manner as to first media cartridge 610-1, either into a second slot of robotic picker device 650 or after first media cartridge 610-1 is placed into an intermediary storage area. Additionally or alternatively, reach carriage 654 may be configured to extend deeper into storage slot 634 so as to retrieve second media cartridge 610-2 from second portion 614, or in circumstances where second media cartridge 610-2 is only partially pushed into first portion 612.

To re-insert a media cartridge into the storage slot 634, the reverse sequence of positions described with respect to FIGS. 7A-C may be performed. For example, reach motor 658 may push reach carriage 654 towards storage slot 634 while holding first media cartridge 610-1. Reach carriage 654 and first media cartridge 610-1 may push second media cartridge 610-2 back into second position 614. In doing so, latch 635 may slide into the deactivated position along the adjacent side of first media cartridge 610-1 until it engages with latch deactivator 657 when first media cartridge 610-1 is inserted. Picker fingers 656A and 656B may then be moved into the open position to disengage from first media cartridge 610-1. In some embodiments, disengaging the picker fingers may similarly disengage latch deactivator 657 from latch 635 so as to place latch 635 back into the activated position to secure first media cartridge 610-1 back in the first portion 612 of storage slot 634.

Returning to FIG. 3, in order to fit within size standards of a particular storage facility, the retrieval assembly 140 and robotic picker device 150 may operate within a tight interior space 104 of the frame 102. As such, the robotic picker device 150 may have features that enable movement within the tight interior space 104. For example, as depicted in FIG. 6 with respect to dual-slot robotic picker device 650, picker head 652 may be substantially circular in shape so that picker head 652 may rotate between various orientations within the interior space 104 without interacting with other components of media library system 100. For example, when retrieving or re-inserting the media cartridge 110 into a storage slot 134, the picker head 652 may be rotated to a first orientation in which a slot (e.g., 655-1 or 655-2) is aligned with an opening 133 of the storage slot 134. When inserting or retrieving the media cartridge 110 from a media drive 122, the picker head 652 may be rotated to a second orientation in which a slot is aligned with the media drive 122. The picker heads of the robotic picker devices described herein may be rotatable into any suitable orientation including the first and second orientations described above, a third orientation so that a slot is aligned with a storage slot 134 of a different media storage area 130.

It can be appreciated that the media library system 100 may not be limited to a single retrieval assembly 140 and robotic picker device 150. Media library system 100 may include two or more retrieval assemblies 140. For example, media library system 100 may include a first retrieval assembly 140 for moving media cartridges 110 from a first media storage portion 130 and a second retrieval assembly 140 for moving media cartridges 110 from a second media storage portion 130. The two retrieval assemblies 140 may be positioned adjacent to each other. Alternatively or additionally, media library system 100 may include two or more retrieval assemblies 140 stacked on top of each other.

In some embodiments, media library system 100 may additionally have one or more features for supporting the functionality of the media library system 100, disposed within and supported by frame 102. For example, media library system 100 may include a power supply 106 and a controller 108 disposed within the frame. However, the technology is not limited in this respect and power supply 106 and controller 108 may be disposed separately from frame 102 and may be operatively coupled (via wired or wireless means) to media library system 100. Additionally or alternatively, media library system 100 may include a graphical user interface to facilitate interaction between and operation of the media library system 100 and a user.

The power supply 106 may provide electrical power in a well-known manner to the one or more media drives 122, the retrieval assembly 140, the controller 108, a graphical user interface for interacting with the media library system 100, and/or additional media library systems 100. The power supply 106 can be interfaced with these components as well as with an external power source in a well-known manner using industry-standard cabling and connections. Alternatively, the power supply 106 can be interfaced with these components in another manner.

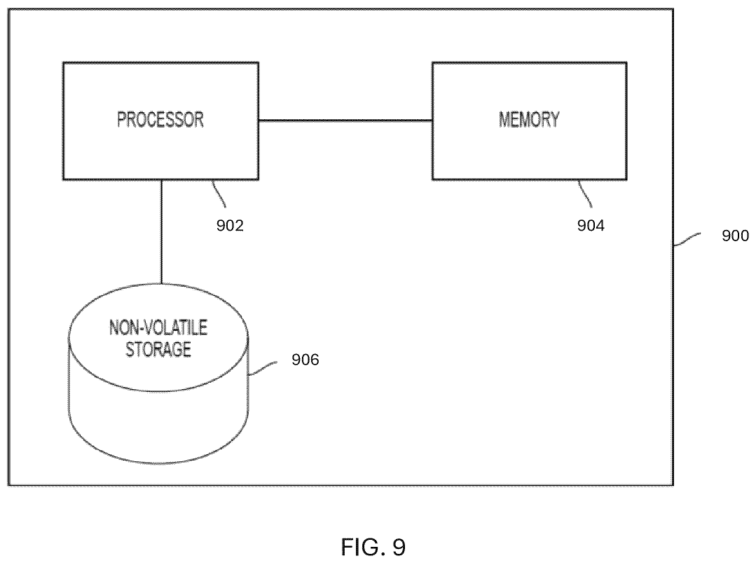

The controller 108 may provide various controls for overseeing and controlling the functionality of the media library system 100. The controller 108 can have any suitable design, many of which are well-known in the industry. For example, in some embodiments, the controller 108 can include a standard driver interface unit for receiving digital commands and translating the commands into driving currents, such as step pulses for controlling stepper motors. In another embodiment, the controller 108 can include a standard programmable general-purpose computer (e.g., as described with respect to FIG. 9) formed on a single plug-in card unit and can include a programmed microprocessor or microcontroller, memory, communication interface, control interface, connectors, etc. Alternatively, the controller 108 may have a different design and/or the controller 108 can be positioned within the media library 10 in a different position or manner than that illustrated in FIG. 3.

The media library 10 can use well-known industry standard cabling and communication protocols between the controller 108 and other structures of the media library system 100. Cabling and electrical characteristics including signaling protocols can be generally standardized, and the logical message protocols can be either proprietary or standardized as known to those skilled in the art. Alternatively or additionally, controller 108 may be configured to communicate with other components and structures of media library system 100 via a wireless communication protocol (e.g., WiFi, Bluetooth, etc.).

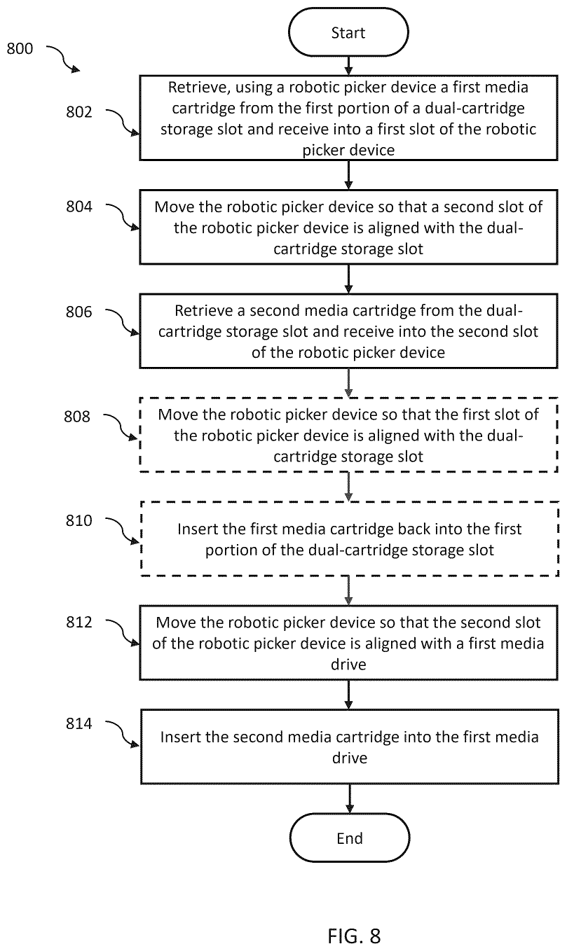

FIG. 8 is a flow chart for an illustrative process 800 of retrieving a media cartridge from a media cartridge storage slot of a media library, according to some embodiments. Process 800 begins, at step 802, by retrieving, using a robotic picker device (e.g., robotic picker device 150 or 650) a first media cartridge from the first portion of a dual-cartridge storage slot and receive the first media cartridge into a first slot of the robotic picker device. For example, as described above with respect to FIG. 3, assembly mover system 146 may move the robotic picker device 150 so that the first slot is aligned with the opening (e.g., 133) of a storage slot 134. The robotic picker device 150 may retrieve the first media cartridge (e.g., media cartridge 610-1) from storage slot 134 as described with respect to FIGS. 7A-C, and hold the first media cartridge in the first slot.

As step 804, process 800 proceeds by moving the robotic picker device so that a second slot of the robotic picker device is aligned with the dual-cartridge storage slot. For example, in some embodiments, the robotic picker device may be robotic picker device 650 of FIG. 6. Robotic picker device 650 may receive the first media cartridge received at step 802 in slot 655-1. Assembly mover system 146 may then move robotic picker device 650 so that slot 655-2 is aligned with the storage slot 134 (e.g., aligned with opening 133 of storage slot 134). However, it can be appreciated that in some embodiments, both slot 655-1 and 655-2 may be configured in a similar manner and can retrieve the first media cartridge interchangeably.

At step 806, process 800 then proceeds by retrieving, with the robotic picker device a second media cartridge from the dual-cartridge storage slot and receive the second media cartridge into the second slot of the robotic picker device. In some embodiments, as described above, the second slot may have a respective reach carriage (e.g., reach carriage 650) and picker arms that may be configured to reach further into the storage slot, so that the second media cartridge may be retrieved from a second portion of the storage slot. However, the technology is not limited in this respect. Rather, additionally, or alternatively, in some embodiments, having retrieved the first media cartridge from the storage slot, the second media cartridge in the storage slot (e.g., second media cartridge 610-2) may be at least partially pushed from the second portion of the storage slot to the first portion of the storage slot. In that way, the reach carriage and the picker arms of the second slot do not need to extend as deep into the storage slot. With either configuration, the second media cartridge may be received in a similar manner as to the first media cartridge as described above with respect to FIGS. 7A-7C.

Optionally, process 800 may proceed at steps 808 and 810 to move the robotic picker device so that the first slot of the robotic picker device is again aligned with the dual-cartridge storage slot and insert the first media cartridge back into the first portion of the dual-cartridge storage slot. For example, reinserting the first media cartridge back into the storage slot so that the robotic picker device does not need to move back to the storage slot to return the first media cartridge that is not being used in the media drives. However, in some embodiments, the second media cartridge retrieved may only be used by a media drive for a brief period. As such, the first media cartridge may be held by the robotic picker device until the conclusion of process 800. In that way, process 800 may minimize subsequent robotic picker device moves by either including or excluding steps 808 and 810.

Process 800 proceeds at step 812 to move the robotic picker device so that the second slot of the robotic picker device is aligned with a first media drive. Moving the robotic picker device from the storage slot to the media drives may involve vertical, lateral, longitudinal, and rotational movement of the robotic picker device. For example, an assembly mover system 146 as described with respect to FIG. 3 may move the robotic picker assembly laterally between media storage areas, longitudinally along the length of the media library, and vertically along the racks between rows of storage slots and media drives. The robotic picker device may include a rotatable head that can rotate between various orientations and moving the robotic picker device so that the second slot of the robotic picker device is aligned with the first media drive may comprise rotating between a first orientation where the slot is facing a media storage area and a second orientation where the slot is facing the media drives.

After the second slot is properly aligned with the first media drive, at step 814 process 800 proceeds by inserting the second media cartridge into the first media drive. Robotic picker device may insert the second media cartridge into the first media drive by any suitable method. For example, as described above, the robotic picker device may insert media cartridges following the insertion process described with respect to FIGS. 7A-C. The reach motor may move the reach carriage forward towards the media drive. Once the second media cartridge is inserted, the picker fingers may disengage from the second media cartridge into the open position. The reach motor may retract the reach carriage back into the second slot and the picker fingers may be moved to a closed position.

After use of the media cartridge by the media drives, the second media cartridge may be returned to the storage slot. In some embodiments, when returning the media cartridge to the storage slot after use by the media drives, the orientation of the two media cartridges in the storage slot may be switched so that the second media cartridge is subsequently stored in the first portion of the storage slot and the first media cartridge is stored in the second portion. In other embodiments, the first media cartridge may be retrieved by the robotic picker device prior to returning the second media cartridge back to the storage slot so the orientation remains the same.

FIG. 9 shows a block diagram of an example computing device 900 that may be used to implement embodiments of the technology described herein. For example, controller 108 of FIG. 3 may be implemented as computer system 900. The computing device 900 includes one or more computer hardware processors 902 and non-transitory computer-readable storage media (e.g., memory 904 and one or more non-volatile storage devices 906). The processor(s) 902 may control writing data to and reading data from (1) the memory 904; and (2) the non-volatile storage device(s) 906. To perform any of the functionality described herein, the processor(s) 902 may execute one or more processor-executable instructions stored in one or more non-transitory computer-readable storage media (e.g., the memory 904), which may serve as non-transitory computer-readable storage media storing processor-executable instructions for execution by the processor(s) 902.

The computing device 900 may be a portable computing device (e.g., a smartphone, a tablet computer, a laptop, or any other mobile device), a computer (e.g., a desktop, a rack-mounted computer, a server, etc.), or any other type of computing device. The portable computing device may be operatively coupled to one or more components of the media library, e.g. over a communication network using a wireless communication protocol.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B), in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

The terms “approximately” and “about,” or any similar term, may be used to mean within ±20% of a target value in some embodiments, within ±10% of a target value in some embodiments, within ±5% of a target value in some embodiments, within ±2% of a target value in some embodiments. The terms “approximately” and “about” may include the target value.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A media library system, comprising:
a frame;
a media storage portion supported by the frame, the media storage portion comprising a plurality of storage magazines each having multiple media storage slots configured to hold at least one media cartridge;
a media drive portion supported by the frame, the media drive portion comprising a plurality of moveable drives arranged in two or more columns of drives, each particular drive of one or more of the plurality of moveable drives being configured to read data from a media cartridge when the media cartridge is inserted into the particular drive, the plurality of moveable drives comprising:
a first set of moveable drives are arranged in a first column; and
a second set of moveable drives are arranged in a second column,
wherein moveable drives in the plurality of moveable drives are configured to be moved among multiple positions in the media drive portion; and
a robotic picker device configured to selectively retrieve a media cartridge from a storage slot in the media storage portion and place the media cartridge into one of the plurality of moveable drives in the first position.

2. The media library system of claim 1, further comprising:
a controller configured to:
identify one or more moveable drives in the first set to be moved;
cause movement of the one or more identified moveable drives out of the first column to provide a space in the first column; and
cause movement of one or more moveable drives in the second set out of the second column and into the space in the first column.

3. The media library system of claim 2, wherein the identified one or more moveable drives consists of one moveable drive in the first set, consists of a subset of the moveable drives in the first set, or consists of all of the moveable drives in the first set.

4. The media library system of claim 2, further comprising;
at least one movement apparatus for moving one or more of the moveable drives.

5. The media library system of claim 1,
wherein the frame has a front end and a back end, and
wherein the frame has a plurality of magazine openings extending from the front end to the back end configured to receive respective storage magazines of the plurality of storage magazines, at least some of the storage magazines having dual-cartridge storage slots configured to hold two media cartridges.

6. The media library system of claim 1, further comprising one or more of a stepper motor, moveable belt, or mechanical pusher configured to move one or more of the moveable drives.

7. The media library system of claim 1, wherein the media cartridges are tape cartridges and the moveable drives are tape drives configured to read data from the tape cartridges.

8. A media library system, comprising:
a frame;
a media storage portion supported by the frame, the media storage portion comprising a plurality of storage slots configured to hold a respective plurality of media cartridges therein;
a media drive portion supported by the frame, the media drive portion comprising a plurality of moveable drives physically arranged in two or more columns of drives, each particular drive of one or more of the plurality of moveable drives being configured to read data from a media cartridge when the media cartridge is inserted into the particular drive, and wherein the moveable drives are configured to be moved between a plurality of positions in the media drive portion; and
a robotic picker device configured to selectively retrieve a media cartridge from a storage slot in the media storage portion and place the media cartridge into one of the plurality of moveable drives.

9. The media library system of claim 7, further comprising a controller wherein:
a first set of the plurality of moveable drives is arranged in a first column;
a second set of the plurality of moveable drives is arranged in a second column; and
the controller is configured to:
identify one or more moveable drives in the first set to be moved;
cause movement of the one or more identified moveable drives out of the first column to provide a space in the first column; and
cause movement of one or more moveable drives in the second set out of the second column and into the space in the first column.

10. The media library system of claim 9, wherein the identified one or more drives consists of one moveable drive in the first set, consists of a subset of the moveable drives in the first set, or consists of all of the moveable drives in the first set.

11. The media library system of claim 9, wherein the controller is configured to move the identified one or more moveable drives to be moved by controlling at least one movement apparatus configured to move one or more of the moveable drives.

12. The media library system of claim 9, further comprising one or more of; a stepper motor, moveable belt, or mechanical pusher configured to move one or more of the moveable drives.

13. The media library system of claim 9, wherein:
the robotic picker device is configured to move in an interior space of the media library;
openings of storage slots in the media storage portion, through which media cartridges pass during retrieval or placement in the storage slots, are accessible by the robotic picker device in the interior space;
openings of the moveable drives in the first column, through which media cartridges pass during retrieval or placement in the moveable drives, are accessible by the robotic picker device in the interior space; and
openings of the moveable drives in the second column, through which media cartridges pass during retrieval or placement in the moveable drives, are not accessible by the robotic picker device in the interior space.

14. The media library system of claim 8,
wherein the frame has a front end and a back end, and
wherein the storage slots of the media storage portion are arranged in a column having a plurality of storage magazines, the storage magazines extending from the front end to the back end of the frame and configured to each hold a subset of storage slots of the plurality of storage slots and wherein at least some of the storage slots are dual-cartridge storage slots configured to hold two media cartridges.

15. The media library system of claim 8, wherein the media cartridges are tape cartridges and the media drives are tape drives configured to read data from and write data to the tape cartridges.

16. A method performed by a media library system, the media library system comprising a plurality of storage slots configured to receive media cartridges, a plurality of moveable drives arranged in two or more columns including a first column having moveable drives in a first position and a second column having moveable drives in a second position, a robotic picker device, and a controller, the method comprising causing the controller to perform:
identifying one or more moveable drives in the first column to be moved;
causing movement of the identified one or more moveable drives out of the first column to provide a space in the first column; and
causing movement of one or more moveable drives out of the second column and into the space in the first column.

17. The method of claim 16, wherein causing movement of the identified one or more moveable drives by controlling at least one movement apparatus configured to move moveable drives between columns of the two or more columns.

18. The method of claim 16, wherein identifying one or more moveable drives in the first column to be moved comprises:
receiving information indicative of whether the one or more moveable drives in the first column are occupied by media cartridges of the plurality of media cartridges, and
identifying the one or moveable drives in the first column to be moved based at least in part on the information indicative of whether the one or more moveable drives are occupied by media cartridges.

19. The method of claim 16, wherein causing movement of the identified one or more moveable drives out of the first column comprises causing movement of a subset of the moveable drives in the first column out of the first column.

20. The method of claim 16, wherein causing movement of the identified one or more moveable drives out of the first column comprises moving all of the moveable drives in the first column out of the first column.
